(19) United States
(12) Patent Application Publication
(10) Pub. No.: US 2024/0188165 A1
(43) Pub. Date: Jun. 6, 2024

(54) SYSTEMS AND METHODS FOR INFORMATION TRANSFER

(71) Applicant: ZTE Corporation, Shenzhen (CN)

(72) Inventors: Ying HUANG, Shenzhen (CN); Lin CHEN, Shenzhen (CN)

(73) Assignee: ZTE Corporation, Shenzhen (CN)

(21) Appl. No.: 18/430,213

(22) Filed: Feb. 1, 2024

Related U.S. Application Data
(63) Continuation of application No. PCT/CN2021/110715, filed on Aug. 5, 2021.

(51) Int. Cl. H04W 76/20; H04W 28/06; H04W 88/08; H04W 92/24

(52) U.S. Cl. CPC H04W 76/20; H04W 28/06; H04W 88/08; H04W 92/24

(57) ABSTRACT

Presented are systems and methods related to radio resource control (RRC) message delivery. In some embodiments, a first integrated access and backhaul (IAB) entity sends to a second IAB entity a message related to RRC message delivery. The first IAB entity can comprise an IAB node or IAB donor DU. The second IAB entity can comprise an IAB donor. The message can comprise a RRC message delivery status to indicate that a buffered RRC message is discarded at the LAB node or IAB donor DU. In some embodiments, the RRC message delivery status includes an identifier of the RRC message which triggers the RRC message delivery status.

### CROSS-REFERENCE TO RELATED APPLICATION

This application claims the benefit of priority under 35 U.S.C. § 120 as a continuation of International Patent Application No. PCT/CN2021/110715, filed on Aug. 5, 2021, the disclosure of which is incorporated herein by reference in its entirety.

### TECHNICAL FIELD

The disclosure relates generally to wireless communications, including but not limited to systems and methods related to RRC message delivery and/or local re-routing.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium related to RRC message delivery. In some embodiments, a first integrated access and backhaul (IAB) entity sends to a second IAB entity a message related to RRC message delivery. The second IAB entity receives from a first IAB entity a message related to RRC message delivery.

In certain embodiments, the first IAB entity comprises an IAB node (or an IAB distributed unit (IAB-DU)) or IAB donor DU. The second IAB entity can comprise an IAB donor (or IAB donor centralized unit (CU)). The message can comprise a radio resource control (RRC) message delivery status to indicate that a buffered RRC message is discarded at the IAB node or IAB donor DU. In some embodiments, the RRC message delivery status includes an identifier of the RRC message which triggers the RRC message delivery status.

In some embodiments, the first IAB entity comprises an IAB node or IAB donor DU. The second IAB entity can comprises an IAB donor (e.g., an IAB donor CU). The message can comprise a message discard request to indicate to the IAB donor (e.g., IAB donor CU) that a buffered RRC message needs to be discarded at the IAB node or IAB donor DU. The message discard request can include an identifier of the RRC message which triggers the message discard request.

In some embodiments, the first IAB entity comprises an IAB donor (e.g., IAB donor CU). The second IAB entity can comprise an IAB node or IAB donor DU. The message can comprise a discard indication to indicate to the IAB node to discard a corresponding RRC message. The discard indication can include an identifier of the RRC message which triggers the discard indication.

In certain embodiments, the first IAB entity comprises an IAB node (e.g., IAB distributed unit (DU)) or IAB donor DU. The second IAB entity can comprise at least one IAB child node. The message comprises a discard indication to indicate to the at least one IAB child node to discard a corresponding RRC message. The discard indication includes an identifier of the corresponding RRC message which triggers the discard indication.

In some embodiments, the IAB donor (e.g., IAB donor CU) sends a RRC reconfiguration message and the associated identifier to the IAB node via an F1 application configuration (F1AP) message.

At least another aspect is directed to a system, method, apparatus, or a computer-readable medium related to local re-routing. In some embodiments, an integrated access and backhaul (IAB) donor sends to an IAB node a message comprising local re-routing configuration information for the IAB node to perform local re-routing. The IAB node can receive from an IAB donor (e.g., an IAB donor CU) a message comprising local re-routing configuration information for the IAB node to perform local re-routing.

The local re-routing configuration information can include at least one of: a local re-routing report indicator, to indicate whether a local re-routing report is to be generated after the local re-routing; a local re-routing indication, to indicate whether the local re-routing is allowed; a downlink (DL)-uplink (UL) local re-routing indication, to indicate whether at least one of: a DL local re-routing or an UL local re-routing, is allowed; a type 2 or type 4 radio link failure (RLF) indication, to indicate whether the local re-routing is allowed upon receiving at least one of: a type 2 backhaul (BH) RLF indication or a type 4 BH RLF indication; a migration indication, to indicate whether the local re-routing is allowed after an IAB node migration; a flow control indication, to indicate whether the local re-routing is allowed after receiving flow control feedback; at least one of: an intra-donor migration indication or an inter-donor migration indication, to indicate whether the local re-routing is allowed after at least one of: an intra-donor migration or an inter-donor migration of the IAB node; a list of at least one backhaul adaptation protocol (BAP) routing identifier (ID) of packets which are allowed to be rerouted; a list of at least one BAP addresses of the packets which are allowed to be rerouted; or quality of service (QoS) information of the packets which are allowed to be rerouted.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and case of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example scenario of intra-donor migration of an IAB node with descendant nodes, according to some embodiments of the present disclosure;

FIG. 4 illustrates an example scenario of inter-donor migration of an IAB node, in accordance with some embodiments of the present disclosure;

FIG. 5 illustrates an example scenario for buffering a RRC message, in accordance with some embodiments of the present disclosure;

FIG. 6 illustrates a flow diagram of an example method related to RRC message delivery, in accordance with an embodiment of the present disclosure; and

FIG. 7 illustrates a flow diagram of an example method for local re-routing, in accordance with an embodiment of the present disclosure

### DETAILED DESCRIPTION

### 1. Mobile Communication Technology and Environment

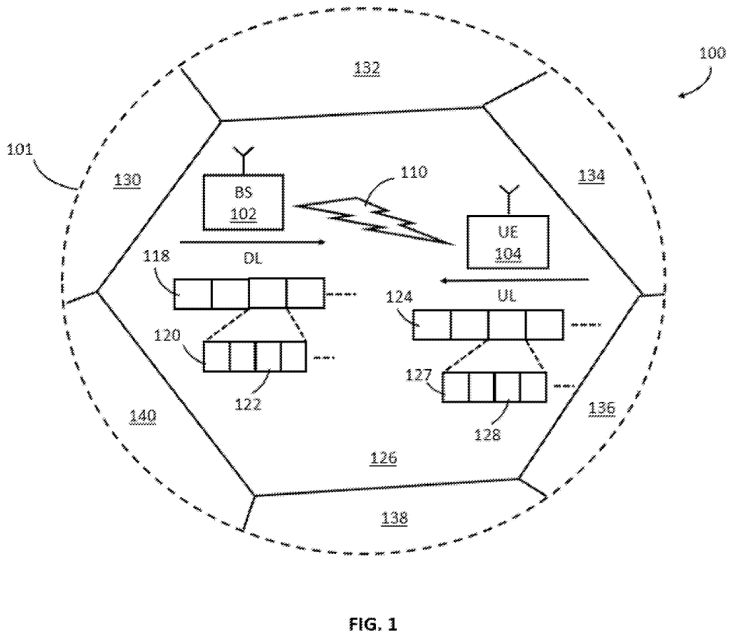

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IOT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

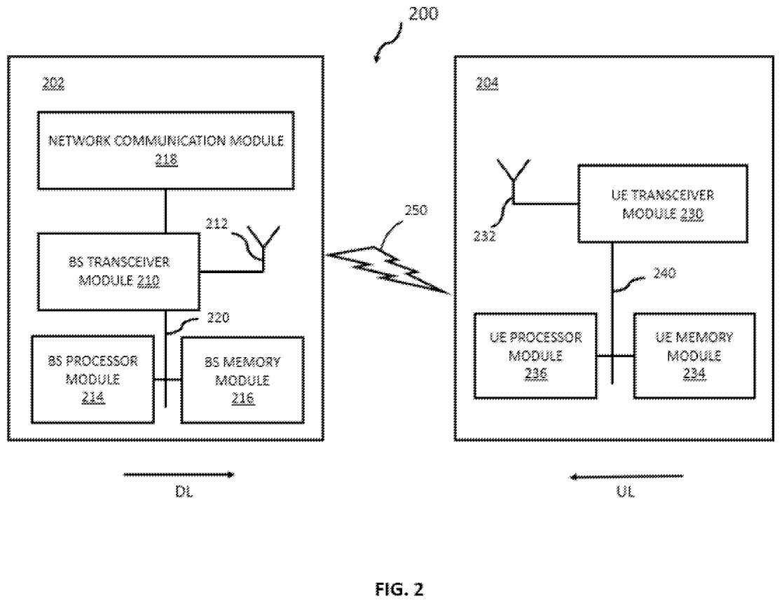

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for RRC Message Management and/or Local Re-Routing

In certain systems (e.g., 5G new radio (NR), Next Generation (NG) systems, 3GPP systems, and/or other systems), an Integrated Access and Backhaul (IAB) supports wireless backhauling via NR for example, enabling flexible and very dense deployment of NR cells while reducing the need for wireline transport infrastructure.

IAB can enable wireless relaying in NG-RAN for instance. The relaying node, referred to as an IAB-node, can support access and backhauling via NR. The terminating node of NR backhauling on network side may be referred to as the IAB-donor, which can represent a gNB with additional functionality to support IAB. Backhauling can occur via a single or via multiple hops.

The IAB-node can support gNB distributed unit (DU) functionality, to terminate the NR access interface to UEs and next-hop IAB-nodes, and to terminate the F1 protocol to the gNB centralized unit (CU) functionality, on the IAB-donor. The gNB-DU functionality on the IAB-node is also referred to as IAB-DU.

In addition to the gNB-DU functionality, the IAB-node can also support a subset of the UE functionality referred to as IAB mobile termination (MT), which includes, e.g., physical layer, layer-2, radio resource control (RRC) and non-access stratum (NAS) functionality to connect to the gNB-DU of another IAB-node or the IAB-donor, to connect to the gNB-CU on the IAB-donor, and to the core network. The IAB-node can access the network using either standalone (SA) mode or E-UTRA NR dual connectivity (EN-DC). In EN-DC, the IAB-node can connect via an E-UTRA to a MeNB, and the IAB-donor can terminate a X2 control plane (X2-C) as a SgNB.

All IAB-nodes that are connected to an IAB-donor via one or multiple hops can form a directed acyclic graph (DAG) topology with the IAB-donor as its root. In this DAG topology, the neighbor node of the IAB-DU or the IAB-donor-DU is referred to as child node and the neighbor node of the IAB-MT is referred to as parent node. The direction toward the child node is referred to as downstream while the direction toward the parent node is referred to as upstream. The IAB-donor can perform centralized resource, topology and route management for the IAB topology.

In some embodiments, inter-donor resource multiplexing is implemented, for which a number of scenarios can apply. The present disclosure, in some aspects, addresses approaches (e.g., systems, devices, methods) to achieve resource multiplexing across multiple IAB donors in an IAB network. In various embodiments, one or more of the following definitions/descriptions can also apply:

IAB-donor: a gNB that provides network access to UEs via a network of backhaul and access links.

IAB-donor-CU: a gNB-CU of an IAB-donor, terminating a F1 interface towards IAB-nodes and an IAB-donor-DU.

IAB-donor-DU: a gNB-DU of an IAB-donor, hosting a IAB backhaul adaptation protocol (BAP) sublayer, and/or providing wireless backhaul to IAB-nodes.

IAB-DU: gNB-DU functionality supported by an IAB-node to terminate the NR access interface to UEs and next-hop IAB-nodes, and/or to terminate the F1 protocol to the gNB-CU functionality, on an IAB-donor.

IAB-MT: an IAB-node function that terminates the Uu interface to a parent node using procedures and behaviors specified for UEs unless stated otherwise. Certain IAB-MT functions can include or correspond to certain IAB-UE functions.

IAB-node: a RAN node that supports NR access links to UEs and NR backhaul links to parent nodes and child nodes. The IAB-node does not support backhauling via long term evolution (LTE) system.

Child node: an IAB-DU's and IAB-donor-DU's next hop neighbor node; the child node is also an IAB-node.

Parent node: an IAB-MT's next hop neighbor node; the parent node can be an IAB-node or IAB-donor-DU

Upstream: Direction towards parent node in IAB-topology.

Downstream: Direction towards child node or UE in IAB-topology.

In various implementations, it may be beneficial to reduce the amount of service interruption relating to migration scenarios. Some example scenarios are discussed herein by way of illustration, and are not intended to be limiting in any manner.

### Example Scenario 1: Intra-Donor Migration (or Handover)

During intra-CU topology adaptation in SA (standalone) mode, both the source and the target parents may be served/controlled/managed by the same IAB-donor-CU. The target parent node may use a different IAB-donor-DU than the source parent node.

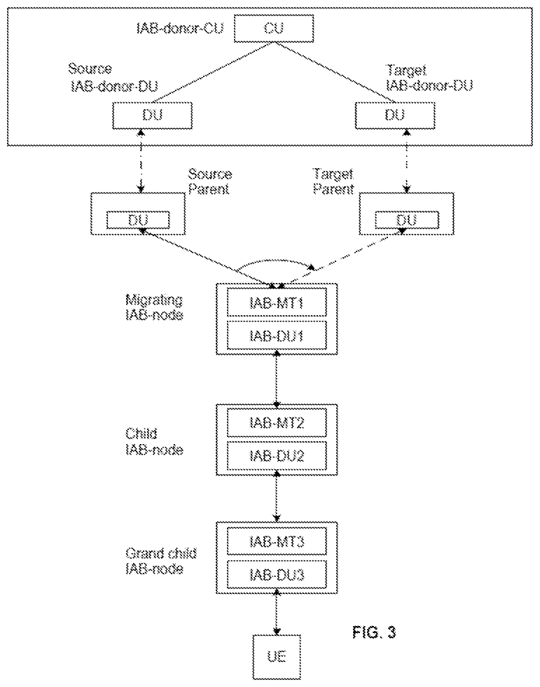

FIG. 3 illustrates an example scenario of intra-donor migration of an IAB node with descendant nodes. For example, as illustrated in FIG. 3, the source and the target parents are served by the same IAB-donor-CU, while the target parent node and the source parent node use (or are served by) different IAB-donor-DUs.

### Example Scenario 2: Inter-Donor CU Migration

In an inter-donor CU migration scenario, the parent IAB node, donor DU and donor CU of the migrating IAB node are changed after migration. Correspondingly, the donor DU, and donor CU of the descendant IAB nodes, and UEs served by the migrating IAB node are to be changed after migration.

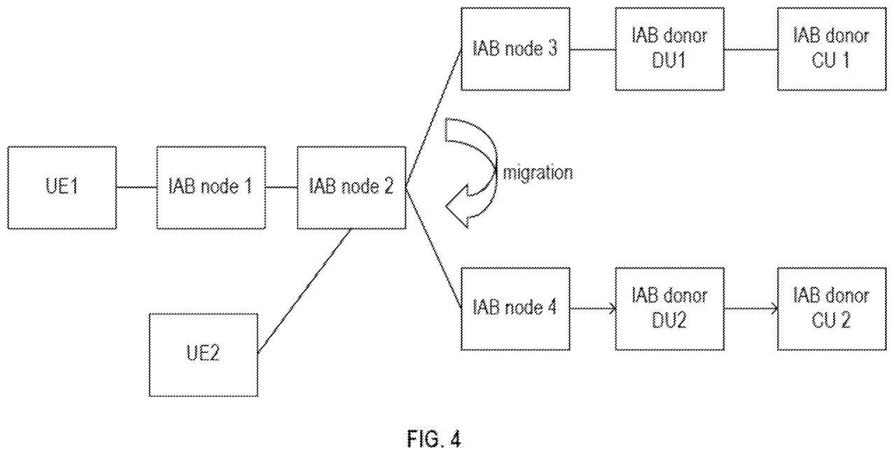

FIG. 4 illustrates an example scenario of inter-donor migration of an IAB node. For example, as illustrated in FIG. 4, the donor DU, the donor CU, and the UE served by the migrating IAB node are changed after migration.

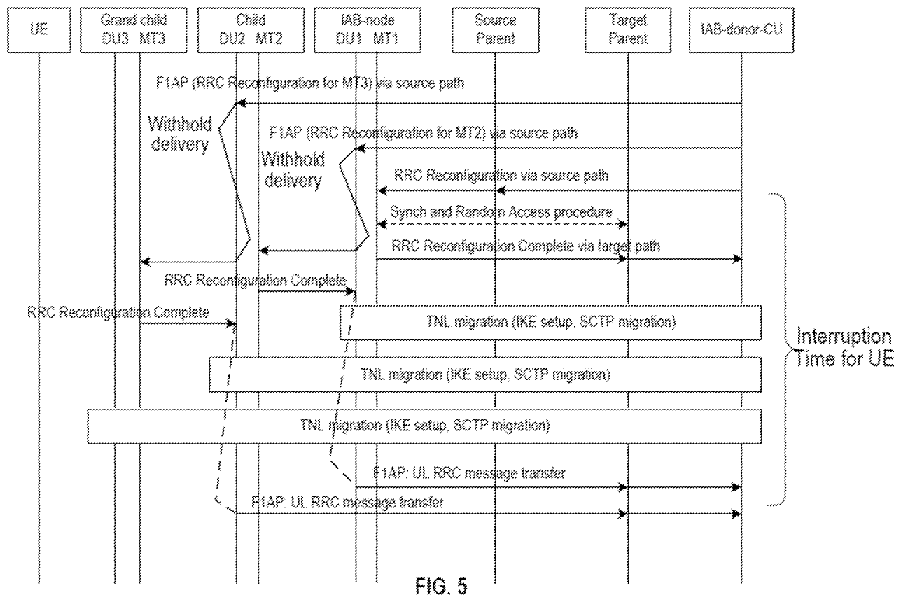

In intra-donor or inter-donor migration, a RRC message (e.g., a RRC Reconfiguration message, or other RRC related message) is to be sent to descendant nodes. The RRC message may include at least one of: new transport network layer (TNL) address(es) that is (are) routable via the target IAB-donor-DU, default backhaul (BH) radio link control (RLC) channel, or default backhaul adaption protocol (BAP) routing identifier (ID) for uplink (UL) Fa control plane (F1-C) or non-F1 traffic on the target path. The IAB donor (IAB donor CU) can transmit/send the RRC message to one or more descendant nodes via a source parent node. One method to transmit the RRC message to descendant nodes via source parent node is to have the RRC message of a descendent node IAB mobile termination (IAB-MT) be withheld/buffered by this descendant node's parent IAB-DU, to be delivered only when a condition is satisfied. An example procedure is provided in FIG. 5. In some aspects, this disclosure provides systems and/or methods for addressing the problem of how to handle the buffered RRC message upon failure of an IAB-MT migration. Various example solutions are described herein, which may be individually applied, or applied in any combination and/or in any order.

### Example Solution 1

If an IAB-MT (or IAB node) migration fails, the buffered RRC message (e.g., RRCReconfiguration message) can be discarded/deleted/purged at the IAB-DU that is co-located with the IAB-MT (or at an IAB donor DU). After successful re-establishment of the IAB-MT, the co-located IAB-DU (or the IAB node) can send a RRC message delivery status to a IAB donor (e.g., IAB donor CU). The RRC message delivery status can be used to indicate/report/inform/declare that the RRC message is discarded/deleted/purged (from a buffer/storage of the IAB-DU or IAB donor DU). The RRC message delivery status can be sent via a F1AP or RRC message. In some implementations, the RRC message delivery status can (e.g., optionally) include an associated identifier of the RRC message which triggers/activates/initiates the RRC message delivery status.

### Example Solution 2

If an IAB-MT (or IAB node) migration fails, the IAB node can send a RRC message discard request to the IAB donor (e.g., to the IAB donor CU). The RRC message discard request can be used to inform (e.g., report to) the IAB donor (or IAB donor CU) that the RRC message is (or is to be) discarded/deleted/removed at the IAB node (IAB DU) or IAB donor DU. The RRC message discard request can be sent via a F1AP or RRC message. In some implementations, the RRC message discard request can (e.g., optionally) include an associated identifier of the RRC message which triggers/initiates/activates the RRC message discard request.

### Example Solution 3

The IAB donor (e.g., IAB donor CU) can send/transmit a discard indication to the IAB node or IAB donor DU to indicate/request/instruct the IAB node to discard/purge the corresponding RRC message (from the buffer/storage of IAB-DU or IAB donor DU). The discard indication can be sent to IAB node or IAB donor DU via a F1AP or RRC message. In some implementations, the discard indication includes an associated identifier of the RRC message which triggers/initiates/activates the discard indication.

### Example Solution 4

If an IAB-MT (or IAB node) migration fails, the IAB node (e.g., via the IAB-DU collocated with the IAB-MT) can send a discard indication to one or more or all of its child IAB nodes via a BAP control PDU (or other type of message). The discard indication can indicate to the at least one IAB child node to discard a corresponding RRC message. After receiving the discard indication from the parent IAB-DU, the IAB-DU can send a discard indication to its child IAB node(s) via a BAP control PDU (or other type of message). In some implementations, the discard indication includes an associated identifier of the RRC message which triggers/activates the RRC message discard request.

### Example Solution 5

An IAN donor (e.g., IAB donor CU) can send a RRC message (e.g., a RRC reconfiguration message) and the associated identifier to the IAB node via an F1AP message. As an example, the RRC message delivery status discussed herein can include the associated identifier of the RRC message which triggers the RRC message delivery status. In another example, the RRC message discard request discussed herein may include the associated identifier of the RRC message which triggers the RRC message discard request. In yet another example, the discard indication discussed herein may include the associated identifier of the RRC message which triggers the RRC message discard request. The identifier of the RRC message can be an index of the RRC message or a packet data convergence protocol (PDCP) serial number (SN) for the RRC message.

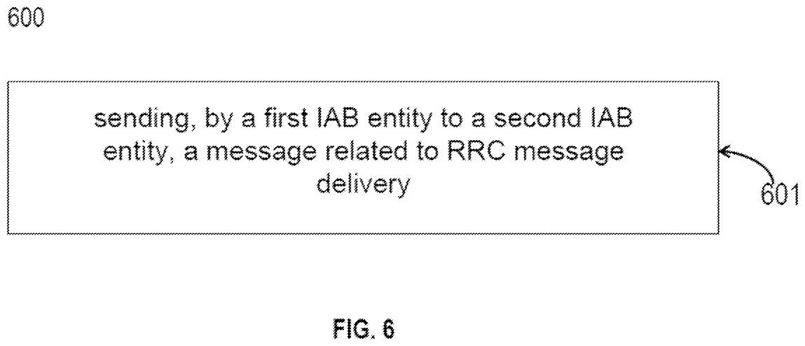

FIG. 6 illustrates a flow diagram of a method 600 for transferring updated information. The method 600 may be implemented using any of the components and devices detailed herein in conjunction with FIGS. 1-5. In overview, the method 600 may include a first first integrated access and backhaul (IAB) entity sending to a second IAB entity a message related to RRC message delivery (601).

Referring now to operation (601), and in some embodiments, a first integrated access and backhaul (IAB) entity sends/transmits to a second IAB entity a message related to RRC message delivery. The second IAB entity can receive from the first IAB entity the message related to RRC message delivery.

In certain embodiments, the first IAB entity comprises an IAB node (or an IAB distributed unit (IAB-DU)) or IAB donor DU. The second IAB entity can comprise an IAB donor (or IAB donor centralized unit (CU)). The message can comprise a radio resource control (RRC) message delivery status to indicate/report/inform that a buffered RRC message is discarded/deleted/purged/inactivated at the IAB node or IAB donor DU. In some embodiments, the RRC message delivery status includes an identifier of the RRC message which triggers/initiates/generates/activates the RRC message delivery status.

In some embodiments, the first IAB entity comprises an IAB node or IAB donor DU. The second IAB entity can comprises an IAB donor (e.g., an IAB donor CU). The message can comprise a message discard request to indicate/request to the IAB donor (e.g., IAB donor CU) that a buffered RRC message needs/is to be discarded at the IAB node or IAB donor DU. The message discard request can include an identifier of the RRC message which triggers/initiates/generates/activates the message discard request.

In some embodiments, the first IAB entity comprises an IAB donor (e.g., IAB donor CU). The second IAB entity can comprise an IAB node or IAB donor DU. The message can comprise a discard indication to indicate/request to (e.g., instruct, inform or cause) the IAB node or IAB donor DU to discard a corresponding RRC message. The discard indication can include an identifier of the RRC message which triggers the discard indication.

In certain embodiments, the first IAB entity comprises an IAB node (e.g., IAB distributed unit (DU)). The second IAB entity can comprise at least one IAB child node. The message comprises a discard indication to indicate/request to (e.g., instruct, inform or cause) the at least one IAB child node to discard/delete/purge/invalidate/inactivate a corresponding RRC message. The discard indication includes an identifier of the corresponding RRC message which triggers/activates/initiates the discard indication.

In some embodiments, the IAB donor (e.g., IAB donor CU) sends a RRC reconfiguration message and/or the associated identifier to the IAB node via a message (e.g., an F1 application configuration (F1AP) message).

In another aspect of the present disclosure, an IAB node can perform uplink or downlink packet local re-routing upon one of a number of triggering conditions, such as: upon RLF (radio link failure), upon receiving flow control feedback, or upon receiving a type 2 or type 4 backhaul (BH) radio link failure (RLF) indication. More specifically, if the triggering condition of local re-routing is met/satisfied, the IAB-node may select another backhaul link to forward the packets according to a configured routing table. In this manner, a packet can be rerouted or delivered via an alternative path if a configured path is not available. The present disclosure provides embodiments of systems and/or methods to address the problem of how the IAB donor can control the local re-routing.

In some embodiments, a IAB donor (e.g., IAB donor CU) can send/transmit local rerouting configuration information to an IAB node. Then, the IAB node can perform local rerouting based on the local rerouting configuration information. The local rerouting configuration information can be sent/transmitted via a F1AP or RRC message for instance. The local rerouting configuration info can includes at least one of the following:
a local re-routing report, to indicate whether a local re-routing report may be needed/generated after local re-routing has occurred;
a local re-routing indication, to indicate whether local re-routing is allowed;
a DL/UL local re-routing indication, to indicate whether DL and/or UL local re-routing is allowed;
a type 2 or type 4 radio link failure (RLF) indication, to indicate whether local re-routing is allowed upon receiving a type 2 and/or type 4 BH RLF indication;
a migration indication, to indicate whether local re-routing is allowed after IAB node migration;
a flow control indication, to indicate whether local re-routing is allowed after receiving flow control feedback;
an intra-donor and/or inter-donor migration indication, to indicate whether local re-routing is allowed after IAB node intra-donor and/or inter-donor migration;
a list of backhaul adaptation protocol (BAP) routing IDs of packets which are allowed to be rerouted;
a list of BAP addresses of packets which are allowed to be rerouted; or
quality of service (QOS) information of packets which are allowed to be rerouted, where the QoS information can include priority information.

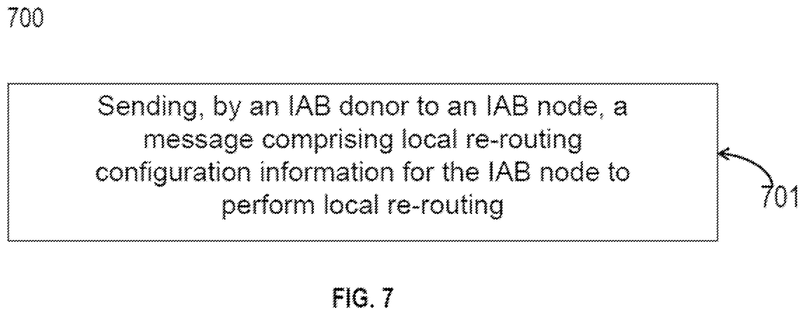

FIG. 7 illustrates a flow diagram of a method 600 for transferring updated information. The method 7600 may be implemented using any of the components and devices detailed herein in conjunction with FIGS. 1-5. In overview, the method 700 may include an integrated access and backhaul (IAB) donor sends to an IAB node a message comprising local re-routing configuration information for the IAB node to perform local re-routing (701).

Referring now to operation (701), and in some embodiments, an integrated access and backhaul (IAB) donor sends to an IAB node a message comprising local re-routing configuration information for the IAB node to perform local re-routing. The IAB node can receive from an IAB donor (e.g., an IAB donor CU) a message comprising local re-routing configuration information (e.g., for the IAB node to perform local re-routing).

The local re-routing configuration information can include at least one of: a local re-routing report indicator, to indicate whether a local re-routing report is to be generated after the local re-routing; a local re-routing indication, to indicate whether the local re-routing is allowed; a downlink (DL)-uplink (UL) local re-routing indication, to indicate whether at least one of: a DL local re-routing or an UL local re-routing, is allowed; a type 2 or type 4 radio link failure (RLF) indication, to indicate whether the local re-routing is allowed upon receiving at least one of: a type 2 backhaul (BH) RLF indication or a type 4 BH RLF indication; a migration indication, to indicate whether the local re-routing is allowed after an IAB node migration; a flow control indication, to indicate whether the local re-routing is allowed after receiving flow control feedback; at least one of: an intra-donor migration indication or an inter-donor migration indication, to indicate whether the local re-routing is allowed after at least one of: an intra-donor migration or an inter-donor migration of the IAB node; a list of at least one backhaul adaptation protocol (BAP) routing identifier (ID) of packets which are allowed to be rerouted; a list of at least one BAP addresses of the packets which are allowed to be rerouted; or quality of service (QoS) information of the packets which are allowed to be rerouted.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
sending, by a first integrated access and backhaul (IAB) entity to a second IAB entity, a message related to radio resource control (RRC) message delivery,
wherein the message comprises an indication to discard a corresponding RRC message.

2. The method of claim 1, wherein at least one of:
the first IAB entity comprises an IAB node or an IAB donor distributed unit (DU);
the second IAB entity comprises an IAB donor; or
the message comprises a RRC message delivery status to indicate that a buffered RRC message is discarded at the IAB node or IAB donor DU.

3. The method of claim 2, wherein the RRC message delivery status includes an identifier of the RRC message which triggers the RRC message delivery status.

4. The method of claim 1, wherein at least one of:
the first IAB entity comprises an IAB node or an IAB donor DU;
the second IAB entity comprises an IAB donor; or
the message comprises a message discard request to indicate to the IAB donor that a buffered RRC message needs to be discarded at the IAB node or IAB donor DU.

5. The method of claim 4, wherein the message discard request includes an identifier of the RRC message which triggers the message discard request.

6. The method of claim 1, wherein at least one of:
the first IAB entity comprises an IAB donor;
the second IAB entity comprises an IAB node or IAB donor DU; or
the message comprises a discard indication to indicate to the IAB node or IAB donor DU to discard a corresponding RRC message.

7. The method of claim 6, wherein the discard indication includes an identifier of the RRC message which triggers the discard indication.

8. The method of claim 1, wherein at least one of:
the first IAB entity comprises an IAB node or IAB donor DU;
the second IAB entity comprises at least one IAB child node; or
the message comprises a discard indication to indicate to the at least one IAB child node to discard a corresponding RRC message.

9. The method of claim 8, wherein the discard indication includes an identifier of the corresponding RRC message which triggers the discard indication.

10. The method of claim 3, wherein the IAB donor sends a RRC reconfiguration message and the associated identifier to the IAB node via an F1 application configuration (F1AP) message.

11. A method, comprising:
receiving, by a second integrated access and backhaul (IAB) entity from a first IAB entity, a message related to radio resource control (RRC) message delivery,
wherein the message comprises an indication to discard a corresponding RRC message.

12. A second integrated access and backhaul (IAB) entity, comprising:
at least one processor configured to:
receive, via a receiver from a first IAB entity, a message related to radio resource control (RRC) message delivery,
wherein the message comprises an indication to discard a corresponding RRC message.

13. A first integrated access and backhaul (IAB) entity, comprising:
at least one processor configured to:
send, via a transmitter to a second IAB entity, a message related to radio resource control (RRC) message delivery,
wherein the message comprises an indication to discard a corresponding RRC message.

14. The first IAB entity of claim 13, wherein at least one of:
the first IAB entity comprises an IAB node or an IAB donor distributed unit (DU);
the second IAB entity comprises an IAB donor; or
the message comprises a RRC message delivery status to indicate that a buffered RRC message is discarded at the IAB node or IAB donor DU.

15. The first IAB entity of claim 14, wherein the RRC message delivery status includes an identifier of the RRC message which triggers the RRC message delivery status.

16. The first IAB entity of claim 13, wherein at least one of:
the first IAB entity comprises an IAB node or an IAB donor DU;
the second IAB entity comprises an IAB donor; or
the message comprises a message discard request to indicate to the IAB donor that a buffered RRC message needs to be discarded at the IAB node or IAB donor DU.

17. The first IAB entity of claim 16, wherein the message discard request includes an identifier of the RRC message which triggers the message discard request.

18. The first IAB entity of claim 13, wherein at least one of:
the first IAB entity comprises an IAB donor;
the second IAB entity comprises an IAB node or IAB donor DU; or
the message comprises a discard indication to indicate to the IAB node or IAB donor DU to discard a corresponding RRC message.

19. The first IAB entity of claim 18, wherein the discard indication includes an identifier of the RRC message which triggers the discard indication.

20. The first IAB entity of claim 13, wherein at least one of:
the first IAB entity comprises an IAB node or IAB donor DU;
the second IAB entity comprises at least one IAB child node; or
the message comprises a discard indication to indicate to the at least one IAB child node to discard a corresponding RRC message.
